(19) United States
(12) Patent Application Publication
(10) Pub. No.: US 2014/0260445 A1
(43) Pub. Date: Sep. 18, 2014

(54) LOCKING DEVICES

(71) Applicant: ATM Link, Inc., Houston, TX (US)

(72) Inventor: Minhas R. Vellani, Sugar Land, TX (US)

(73) Assignee: ATM Link, Inc., Houston, TX (US)

(21) Appl. No.: 14/069,041

(22) Filed: Oct. 31, 2013

Related U.S. Application Data
(60) Provisional application No. 61/801,324, filed on Mar. 15, 2013.

(51) Int. Cl. E05B 15/00

(52) U.S. Cl. CPC E05B 15/00
USPC 70/101

(57) ABSTRACT

Embodiments generally relate to locking devices. In some embodiments, a locking device may be used to secure, for example, a door to a wall. Embodiments of the locking device may include a corner plate and a side plate. One section of the corner plate may be oriented at an angle to another section of the corner plate. The corner plate and the side plate may cooperatively engage at least one lock to prevent relative motion between two surfaces and/or objects when the locking device is in a locked state.

### CROSS-REFERENCE TO RELATED APPLICATION

This application claims the benefit of priority to U.S. Provisional Patent Application No. 61/801,324, filed in the United States Patent and Trademark Office on Mar. 15, 2013, titled “Locking Devices”, the entire contents of which are incorporated herein by reference.

### BACKGROUND

Locking devices can be used to fasten or secure objects together. A hasp, for example, can be used in conjunction with a padlock to secure a door to a doorframe.

Conventional locking devices, however, are not optimally designed to accommodate certain door configurations. For example, some conventional locking devices may not adequately secure the door of an automated/automatic teller machine (ATM). Because they are high-value targets, and because relatively cheap and readily-accessible implements (e.g., a crowbar) can be used to gain mechanical advantage over the security measures currently provided by their manufacturers, ATMs are particularly vulnerable to physical attack. Existing locking devices that aim to safeguard against physical security threats may be inordinately bulky, heavy, expensive to manufacture (and therefore expensive to purchase), difficult to retrofit, and/or inconvenient to use, and are therefore also deficient.

### SUMMARY

Embodiments of the presently disclosed subject matter generally relate to locking devices and methods of using the locking devices.

In some embodiments, a locking device may include a side plate and a corner plate. The side plate may be configured to be affixed to a first surface. The corner plate may be configured to be affixed to a second surface. The corner plate may comprise a lock-distal section and a lock-proximal section. The lock-proximal section may be oriented at an angle to the lock-distal section.

The lock-proximal section of the corner plate and the side plate may be configured to cooperatively engage at least one lock in such a way that the locking device prevents relative motion between the first surface and the second surface when the locking device is in a locked state.

In some embodiments, a locking device may include a wall plate and a door plate. The wall plate may be configured to be mounted to a container wall. The door plate may be configured to be mounted to a container door. The door plate may comprise a lock-distal side and a lock-proximal side. The lock-proximal side may be oriented at an angle to the lock-distal side.

The lock-proximal side of the door plate and the wall plate may be configured to cooperatively engage at least one lock in such a way that the locking device prevents the container door from being opened when the locking device is in a locked state.

In one or more embodiments, a method for locking a container door may involve securing a first plate to a second plate with at least one lock. The first plate may be affixed to a container wall, and the second plate may be affixed to a container door. The second plate may comprise a lock-distal section and a lock-proximal section. The lock-proximal section may be oriented at an angle to the lock-distal section. The lock-proximal section of the second plate and the first plate may be configured to cooperatively engage the at least one lock in such a way that the container door is locked in a closed position when the at least one lock is in a locked state.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

FIG. 1A shows a perspective view of a locking device securing a container door, indicating the general environment in which the locking device may be used, in accordance with one or more embodiments.

FIG. 1B shows a back view of a lock, in accordance with one or more embodiments.

FIG. 2 shows a perspective view of a locking device securing a door of an automated/automatic teller machine (ATM), in accordance with one or more embodiments.

FIGS. 3A-3B show perspective views of a door plate and a wall plate of a locking device, in accordance with one or more embodiments.

FIGS. 4A-4C show front, side, and bottom views, respectively, of a door plate of a locking device, in accordance with one or more embodiments.

FIGS. 5A-5C show front, side, and bottom views, respectively, of a wall plate of a locking device, in accordance with one or more embodiments.

### DETAILED DESCRIPTION

In the following detailed description of exemplary embodiments, specific exemplary embodiments in which aspects of the subject matter disclosed herein may be practiced are described in sufficient detail to enable those skilled in the art to practice the presently disclosed subject matter. The following detailed description is, therefore, not to be taken in a limiting sense. Reference is made to the accompanying drawings, which form a part hereof, and in which are shown by way of illustration of specific embodiments. It is to be understood that other embodiments may be utilized and structural changes may be made without departing from the scope of the present disclosure.

The terminology used herein is for the purpose of describing particular embodiments only and is not intended to limit the subject matter disclosed in the present application. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the presently disclosed subject matter generally relate to locking devices. In one or more embodiments, the locking device may be used to secure a first surface to a second surface and/or a first object to a second object such that the surfaces/objects are immobilized relative to each other.

In some embodiments, the locking device may be used to secure a container door to a container wall. Although the present disclosure primarily describes the locking device in the context of securing an automated/automatic teller machine (ATM) door to an ATM wall, it is understood that the locking device may be used with any other type of container having a similar configuration.

FIG. 1A illustrates a locking device 100 securing a container door 124 to a container wall 120, indicating the general environment in which the locking device may be used, in accordance with one or more embodiments. The locking device may comprise a side plate 104 and a corner plate 108. The terms “side plate” and “wall plate” are used interchangeably herein to describe locking device plate configured to be affixed to a first surface and/or a wall, in accordance with one or more embodiments. The terms “corner plate” and “door plate” are used interchangeably herein to describe a locking device plate configured to be affixed to a second surface and/or a door, in accordance with one or more embodiments.

The side plate 104 may be configured to be affixed to a first surface 120s. In some embodiments, the first surface 120s may comprise an outer surface of the container wall 120.

The corner plate 108 may be configured to be affixed to a second surface 124s. In some embodiments, the second surface 124s may comprise an exterior surface of the container door 124. The corner plate 108 may have a lock-distal section 112 and a lock-proximal section 116. The lock-distal section 112 of the corner plate 108 may be configured to be disposed along and affixed to the front exterior surface 124s of the container door 124. Oriented at an angle to the lock-distal section 112 of the corner plate 108, the lock-proximal section 116 of the corner plate 108 may be disposed along an outer edge 136 of the container door 124. As used herein, the term “at an angle to” means a relative angle greater than 0 degrees. In some embodiments, the lock-proximal section 116 may be configured to be affixed to the outer edge 136 of the container door 124.

The lock-proximal section 116 of the corner plate 108 and the side plate 104 may be configured to cooperatively engage a lock 128. The lock 128 may be disposed at or near the junction of the lock-proximal section 116 of the corner plate 108 and the side plate 104. As will be described in more detail below with reference to FIG. 3, each of the lock-proximal section 116 of the corner plate 108 and the side plate 104 may comprise an engagement element (not shown in FIG. 1A) for cooperatively engaging the lock 128.

In some embodiments, the lock 128 may comprise a padlock having a hidden shackle 130, as depicted in FIG. 1B. For example, the shackle 130 of the lock 128 may be a pin that extends across at least a portion of the body of the lock 128 when the lock 128 is in a locked position. The lock 128 body may have a recess 134 across which a portion of the shackle 130 may extend and at which one or more engagement elements (not shown) of the to-be-locked subject(s) may be disposed to engage the shackle 130. The shackle 130 may be retracted such that it does not completely extend across the recess 134 when the lock 128 is in an unlocked position. When the lock 128 is in an unlocked position, the one or more engagement elements of the to-be-locked subject(s) may be disengaged from the shackle 130. To selectively place the lock 128 in a locked or in an unlocked position, an operator of the lock 128 may manually actuate the locking/unlocking by, for example, inserting a key 152 into a matching keyhole 156 and turning the key. Other manual methods of changing the lock position may include, but are not limited to, entering a combination via a rotary dial, keypad, and/or a touchscreen. In some embodiments, the lock may include digital components. Additionally or alternatively, a change of the lock position may be actuated automatically or semi-automatically by, for example, connecting the lock 128 to a controller that allows for setting a timer or remotely controlling the locking position.

The lock 128 may be any locking means suitable for engaging the lock-proximal section 116 of the corner plate 108 and the side plate 104 such that the plates may be secured together at or near their junction. For example, the lock 128 may use magnetic forces to secure the plates together. The shape and size of the lock 128 may vary depending on the specific application of the locking device 100. Further, in some embodiments, more than one lock 128 may be used.

In one or more embodiments, the locking device 100 may comprise an overlapping portion 148 between the plates when the locking device 100 is in a locked state. As depicted in FIG. 1A, a portion of the lock-proximal section 116 of the corner plate 108 may overlap a portion of the side plate 104. However, as depicted in FIG. 2, a portion of the side plate 104 (204) may overlap a portion of the lock-proximal section 116 (216) of the corner plate 108 in some embodiments. Moreover, the locking device 100 may comprise a plurality of overlapping portions 148, and in some embodiments the plurality of overlapping portions 148 may include a combination of one plate overlapping the other and vice-versa.

The overlapping portion 148 may serve to create a secure fit between the lock-proximal section 116 of the corner plate 108 and the side plate 104. Further, the overlapping portion 148 may serve to increase the security of the locking device 100. By shrouding an underlying portion of one of the plates, that underlying portion is less susceptible to attack due to its inaccessibility. Further, the overlap provides a double layer that may be able to withstand higher bending forces applied thereto as compared to a single layer. In some embodiments, the overlapping portion 148 may be disposed in the vicinity of the lock 128 and/or at or near the junction between the lock-proximal section 116 of the corner plate 108 and the side plate 104. As depicted, the overlapping portion 148 is disposed above and below the lock 128.

FIG. 2 illustrates the locking device 200 securing a door of an automated/automatic teller machine (ATM) 204, in accordance with one or more embodiments. The ATM 204 may include a door 224 and a side wall 220 that form, in part, a container such as an inner safe to which the door 224 may be the designated access point. The door 224 may have a hinged longitudinal side 244 and an exposed longitudinal side 236 opposite the hinged longitudinal side 244. The exposed longitudinal side 236 of the door 224 may be adjacent to the wall 220. In some embodiments, the exposed longitudinal side 236 of the door 224 may be substantially parallel to the wall 220, as depicted in FIG. 2.

A gap 240 may exist between the exposed longitudinal side 236 of the door 224 and the wall 220. The gap 240 is an attractive engagement point for prying open the door 224 of the ATM 202. Upon information and belief, a person can pry open these types of ATM door configurations in less than 30 seconds using a crowbar, despite the ATM 202 having a manufacturer's internal locking mechanism already in place. One type of conventional device used to protect against this type of attack provides a frame that completely wraps around the ATM 202. For various reasons, including size, weight, cost, and inconvenience, the wrap around frame solution may be deficient and/or suboptimal. The locking device 200, in contrast, is relatively small, lightweight, inexpensive, and convenient to install, retrofit, and/or use.

The locking device 200 may comprise a wall plate 204 and a door plate 208. The wall plate 204 may be configured to be mounted to the wall 220, and the door plate 208 may be configured to be mounted to the door 224.

The door plate 208 may comprise a lock-distal side 212 and a lock-proximal side 216. The lock-proximal side 216 may be oriented at an angle to the lock-distal side 212. For example, as depicted in FIG. 2, the lock-proximal side 216 may be substantially perpendicular to the lock-distal side 212. However, other door configurations may require a different relative angle between the lock-proximal side 216 and the lock-distal side 212. As depicted, in some embodiments, at least a portion of the lock-distal side 212 may be shaped to substantially conform to the shape of the front of the door 224, and at least a portion of the lock-proximal side 216 may be shaped to substantially conform to one or both of the exposed longitudinal side 236 of the door 224 and the exterior surface of the wall 220.

In some embodiments, the locking device 200 may be configured to be disposed at a lower right area of the ATM 202, as depicted in FIG. 2. However, it is understood that the locking device 200 may be adapted to be disposed at a different location depending on the door configuration of the particular ATM 202 model.

In some embodiments, at least one of the lock-proximal side 216 of the corner plate 208 and side plate 204 may be configured to shield the lock 128. For example, at least one of the lock-proximal side 216 of the corner plate 208 and the side plate 204 may comprise one or more outwardly protruding shield elements 232. The outwardly protruding shield elements 232 may be disposed in such a way as to surround certain portions or all of the lock 128. In some embodiments, the outwardly protruding shield elements 232 may be disposed circumferentially around at least a portion of the lateral surface area of a cylinder lock 128. Such a configuration of the outwardly protruding shield elements 232 allows for the lock 128 to be protected while engaged, and removed when disengaged.

As depicted, the plates are bolted onto the ATM 202. The wall plate 204 is bolted onto the wall 220, and the corner plate 208 is bolted onto the door 224. In some embodiments, bolts 250 (e.g., high-grade steel bolts), for example, may be used to secure the plates 204, 208 to the ATM 202. In some embodiments, the bolts 250 used may lack a drive on the head so that they cannot easily be removed using a standard tool. The bolts 250 may be combined with one or more washers (not shown) and/or one or more nuts (not shown) on the opposite side of the structure to which the bolt 250 is driven. For example, with reference to the corner plate 208, the bolt 250 may be driven through the door 224 such that the bolt head is disposed at the exterior surface of the door 224, and one or more washers and/or nuts are screwed onto a threaded bolt shaft and disposed at the interior surface of the door 224. In this manner, the bolt head presses the corner plate 208 tightly against the door 224. However, in one or more embodiments, each of the plates may be affixed, or mounted, to a surface, object, door and/or wall by any fastening method suitable for securing the plate to the surface/object/door/wall such that the plate is capable of substantially withstanding external forces applied thereto, thereby maintaining in a fixed manner its position relative to the surface/object/door/wall onto which it is mounted. For example, an adhesive or a magnetic force may be used, alone, or in combination with other suitable fastening methods.

Referring now to FIGS. 3A-5C, components of the locking device 200 are shown in various perspective and orthogonal views in an unmounted state (i.e., not mounted to a container). FIGS. 3A-3B illustrate perspective views of a door plate 208 and a wall plate 204 of the locking device 200, in accordance with one or more embodiments. FIGS. 4A-4C illustrate front, side, and bottom views, respectively, of the door plate 208, in accordance with one or more embodiments. FIGS. 5A-5C illustrate front, side, and bottom views, respectively, of the wall plate 204, in accordance with one or more embodiments.

In one or more embodiments, the lock-proximal side 216 of the door plate 208 may be configured to cooperatively engage the lock 128 (FIGS. 1A-2) in such a way that the locking device 200 prevents relative motion between a first surface and a second surface when the locking device 200 is in a locked state. For example, the locking device 200 may prevent the door 224 from being opened when the locking device 200 is in a locked state.

In some embodiments, the wall plate 204 and the lock-proximal side 216 of the door plate 208 each may comprise a staple flange 324a, 324b. Each of the staple flanges 324a, 324b may define an aperture 328a, 328b. The apertures 328a, 328b may be substantially aligned to cooperatively receive a portion of the shackle 130 (FIG. 1B) of the lock 128 when the locking device 200 is in a locked state. As depicted, staple flange 324a extends outwardly from the wall plate 204, and staple flange 324b extends outwardly from the lock-proximal side 216 of the door plate 208. Although each plate is depicted as having a single staple flange 324a, 324b, it is understood that each plate may also comprise a plurality of staple flanges 324a, 324b, or any other type of engagement element suitable for engaging a lock 128. Further, it is understood that the staple flanges 324a, 324b, or any other type of engagement element suitable for engaging a lock 128, may each define a plurality of apertures 328a, 328b.

The lock 128 may be selectively disengaged from the apertures 328a, 328b. For example, with reference to the particular lock 128 depicted in FIGS. 1A-2, an operator may manually insert the key 152 to the matching keyhole 156, turn the key 152 in a certain direction, and then retract the key 152 in order to withdraw the shackle 130 from at least one of the apertures 328a, 328b. In some configurations, the shackle 130 may need to be withdrawn from all apertures 328a, 328b and the lock removed in order to place the locking device 200 in an unlocked state. When the locking device 200 is in an unlocked state, the locking device 200 does not prevent the door 224 from being opened.

The plates 204, 208 may be manufactured from any material capable of substantially withstanding external forces applied thereto. For example, in some embodiments, the plates 204, 208 may be made of a metal or a metal alloy, such as steel.

On one or more embodiments, the door plate 208 may have an L-shaped cross-section, i.e., the lock-proximal side 216 of the door plate 208 may be substantially perpendicular to lock-distal side 212 of the door plate 208. In some embodiments, each of the lock-proximal side 216 and the lock-distal side 212 of the door plate 208 may comprise width dimensions ranging from approximately 3 inches to approximately 10 inches, length dimensions ranging from approximately 8 inches to approximately 16 inches, and a thickness ranging from approximately ⅛ inch to approximately ¾ inch. The weight of a steel door plate 208 may range from approximately 6 pounds to approximately 10 pounds. The wall plate 204 may have a width dimension ranging from approximately 3 inches to approximately 8 inches, a length dimension ranging from approximately 8 inches to approximately 16 inches, and a thickness of approximately ⅛ inch to approximately ¾ inch. The weight of a steel wall plate 204 may range from approximately 2 pounds to approximately 8 pounds.

However it will be understood that certain parameters, such as the dimensions of the plates, dimensions of the fasteners, number of fasteners, and arrangement of fasteners may vary depending on the particular configuration without departing from the scope of the presently disclosed subject matter.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A device comprising:
a side plate configured to be affixed to a first surface; and
a corner plate configured to be affixed to a second surface, the corner plate comprising:
a lock-distal section; and
a lock-proximal section oriented at an angle to the lock-distal section, the lock-proximal section of the corner plate and the side plate configured to cooperatively engage at least one lock in such a way that the device prevents relative motion between the first surface and the second surface when the device is in a locked state.

2. The device of claim 1, the corner plate configured to span a gap when the device is in a locked state, the gap disposed between the first surface and the second surface.

3. The device of claim 1, the lock-distal section of the corner plate configured to be affixed to the second surface.

4. The device of claim 1, the corner plate configured to be affixed to a door, the door comprising the second surface, the locking device preventing relative motion between the door and the first surface when the device is in a locked state.

5. The device of claim 1, the side plate and the lock-proximal section of the corner plate each comprising a staple flange, each staple flange defining an aperture, the apertures substantially aligned to cooperatively receive a portion of a shackle of the at least one lock when the device is in a locked state.

6. The device of claim 1, the at least one lock comprising a cylindrical padlock having a hidden shackle.

7. The device of claim 1, a portion of the lock-proximal section of the corner plate and a portion of the side plate overlapping when the device is in a locked state.

8. A locking device for a container, comprising:
a wall plate configured to be mounted to a container wall; and
a door plate configured to be mounted to a container door, the door plate comprising:
a lock-distal side; and
a lock-proximal side oriented at an angle to the lock-distal side, the lock-proximal side of the door plate and the wall plate configured to cooperatively engage at least one lock in such a way that the locking device prevents the container door from being opened when the locking device is in a locked state.

9. The locking device of claim 8, the lock-distal side of the door plate configured to be mounted to the container door.

10. The locking device of claim 9, the wall plate and the lock-proximal section of the door plate each comprising a staple flange, each staple flange defining an aperture, the apertures substantially aligned to cooperatively receive a portion of a shackle of the at least one lock when the locking device is in a locked state.

11. The locking device of claim 10, the at least one lock configured to be selectively disengaged from at least one of the apertures.

12. The locking device of claim 11, the at least one lock comprising a cylindrical padlock having a hidden shackle.

13. The locking device of claim 12, a portion of the lock-proximal side of the door plate and a portion of the wall plate overlapping when the device is in a locked state.

14. The locking device of claim 13, the container comprising a safe of an automated/automatic teller machine (ATM).

15. The locking device of claim 14, the container door comprising a hinged longitudinal side and an exposed longitudinal side, the exposed longitudinal side opposite the hinged longitudinal side, the exposed longitudinal side comprising a surface substantially parallel to the container wall.

16. The locking device of claim 15, the lock-proximal side of the door plate configured to be mounted to the exposed longitudinal side of the container door.

17. A method for locking a container door, comprising:
securing a first plate to a second plate with at least one lock, the first plate affixed to a container wall, the second plate affixed to a container door, the second plate comprising:
a lock-distal section; and
a lock-proximal section oriented at an angle to the lock-distal section, the lock-proximal section of the second plate and the first plate configured to cooperatively engage the at least one lock in such a way that the container door is locked in a closed position when the at least one lock is in a locked state.

18. The method of claim 17, the container door comprising a hinged longitudinal side and an exposed longitudinal side, the exposed longitudinal side opposite the hinged longitudinal side, the exposed longitudinal side comprising a surface substantially parallel to the container wall.

19. The method of claim 18, the first plate and the lock-proximal section of the second plate each comprising a staple flange, each staple flange defining an aperture, the apertures substantially aligned to cooperatively receive a portion of a shackle of the at least one lock when the locking device is in a locked state.

20. The method of claim 19, the at least one lock configured to be selectively disengaged from at least one of the apertures.
